(19) United States
(12) Patent Application Publication
(10) Pub. No.: US 2025/0061640 A1
(43) Pub. Date: Feb. 20, 2025

(54) Realtime 3D Performance Management System

(71) Applicant: Ascendant Studios, LLC, San Rafael, CA (US)

(72) Inventor: Mark Maratea, San Rafael, CA (US)

(21) Appl. No.: 18/807,966

(22) Filed: Aug. 17, 2024

Related U.S. Application Data
(60) Provisional application No. 63/533,331, filed on Aug. 17, 2023.

(51) Int. Cl. G06T 15/00; G06F 11/34

(52) U.S. Cl. CPC G06T 15/005; G06F 11/3428; G06F 11/3442

(57) ABSTRACT

A real-time performance management system for controlling rendering performance and quality of a 3-D software run on a user device, by making quantifiable choices by a user is provided. A user launches a game to scan process of the user device in which the user wants to play. The current running setup is scanned to assess how game features will perform. A total performance budget for both the GPU and the CPU is obtained, reflecting the maximum capacity of your hardware. The current budget allocation is obtained to see how resources are being used. If the allocation is less than the total budget, the user experiences smooth gameplay. A larger gap between allocation and budget indicates better performance and if the allocation exceeds budget, the user experiences reduced performance, as visual fidelity increases. The user can adjust the graphics settings which causes the allocation to increase or decrease

### CLAIM FOR PRIORITY

This application claims priority from a prior utility provisional application with the application No. 63/533,331 filed on Aug. 17, 2023. The entire collective teachings thereof being herein incorporated by reference.

### FIELD OF THE INVENTION

The present invention relates to performance management, and more particular to a real-time system and a related method for controlling a real-time 3-D software and adjusting the software's rendering performance and quality, by making quantifiable choices by a user, within the context of a total quantifiable capacity of the user device's specific capabilities.

### BACKGROUND OF THE INVENTION

The rapid advancement of technology has significantly transformed the video gaming industry, introducing various digital tools and platforms aimed at enhancing the gaming experience. Traditional customization mechanisms have evolved to integrate more personalized approaches, aiming to cater to individual customer preferences. Despite these advancements, existing systems often fall short in providing a truly unified and personalized adjustable gaming experience that seamlessly blends different adjustable variables.

In recent years, the importance of real-time performance management in user devices, particularly concerning 3D software applications such as video games, has become increasingly critical. With the advent of advanced 3D graphics and high-definition displays, users demand smooth and immersive experiences, pushing the capabilities of their devices to the limit.

Current solutions available for monitoring and managing the performance of 3D software applications on user devices generally focus on either the visual fidelity or the performance metrics such as frame rates. These solutions often utilize visual or thermal sensing methods, wherein the system adjusts the rendering quality of the software based on the available hardware resources, like the graphics processing unit (GPU) and central processing unit (CPU). However, these approaches come with significant limitations.

For instance, most existing systems do not offer a comprehensive real-time assessment of both the GPU and CPU performance budgets. They either provide generic recommendations based on pre-set configurations or require manual adjustments that may not optimize the device's performance effectively. Additionally, the inability to dynamically and precisely balance the rendering quality with the performance capabilities of the hardware leads to sub-optimal user experiences, particularly in high-demand scenarios such as gaming, where frame rates and visual quality are crucial.

Despite advancements in performance management technologies, current methods fall short in several areas:

Lack of Integrated Systems: Existing solutions do not provide an integrated system that can autonomously or semi-autonomously adjust the rendering settings of 3D software in real-time based on a thorough analysis of the device's specific hardware capabilities.

Manual Intervention: Users are often required to manually adjust settings, which can be cumbersome and may not always yield the best performance outcomes, especially for non-technical users.

Inadequate Real-Time Feedback: Many systems do not offer real-time feedback on how changes in settings affect both GPU and CPU performance simultaneously, leaving users to rely on trial and error, which can be time-consuming and frustrating.

Limited Customization: The degree of customization available to users is often limited, with many systems offering only basic settings adjustments that do not cater to individual preferences for balancing visual quality and performance.

Accordingly, there is a clear need for a more sophisticated system that can manage the performance and render quality of 3D software applications in real-time. Such a system should allow for fine-grained control and customization, providing users with the ability to make informed, quantifiable choices that optimize their experience based on their device's unique hardware capabilities.

### BRIEF SUMMARY OF THE INVENTION

Embodiments of the present invention provide novel never before seen video gaming experience management systems which allow individual users to customize their own gaming experience. Embodiments of the present invention allow for fine-grained control and customization, providing users with the ability to make informed, quantifiable choices that optimize their experience based on their device's unique hardware capabilities. The invention described herein addresses these needs by providing a novel system and method for real-time performance management, overcoming the drawbacks of existing technologies.

The following presents a simplified summary of the invention in order to provide a basic understanding of some aspects of the invention. This summary is not an extensive overview of the present invention.

According to an aspect of present invention there is provided a real-time performance management system for controlling rendering performance and quality of a 3-D software run on a user device, by making quantifiable choices by a user. Initially, a user launches a game to initiate the hardware scan process of the user device in which the user wants to play. The current running setup is scanned to assess how game features will perform on the installed user device hardware. A total performance budget for both the GPU and the CPU is obtained, reflecting the maximum capacity of your hardware. The current budget allocation for GPU and CPU is obtained to see how resources are being used. If the allocation is less than the total budget, the user experiences high frame rates and smooth gameplay. A larger gap between allocation and budget indicates better performance and if the allocation exceeds the total budget, the user experiences reduced frame rates and performance, as visual fidelity increases. The user can adjust the graphics settings which causes the allocation to increase or decrease. Some settings have higher impact than others. User can increase the quality of a settings they care more about.

According to another aspect of present invention there is provided a real-time method for controlling rendering performance and quality of a 3-D software run on a user device, by making quantifiable choices by a user. Initially, a user launches a game to initiate the hardware scan process of the user device in which the user wants to play. The current running setup is scanned to assess how game features perform on the installed user device hardware. A total performance budget for both the GPU and the CPU is obtained, reflecting the maximum capacity of your hardware. The current budget allocation for GPU and CPU is obtained to see how resources are being used. If the allocation is less than the total budget, the user experiences high frame rates and smooth gameplay. A larger gap between allocation and budget indicates better performance and if the allocation exceeds the total budget, the user experiences reduced frame rates and performance, as visual fidelity increases. The user can adjust the graphics settings which causes the allocation to increase or decrease. Some settings have higher impact than others. User can increase the quality of a settings they care more about.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

A clear understanding of the key features of the invention summarized above may be had by reference to the appended drawings, which illustrate the method and system of the invention, although it will be understood that such drawings depict preferred embodiments of the invention and, therefore, are not to be considered as limiting its scope with regard to other embodiments which the invention is capable of contemplating. Accordingly:

FIG. 1 illustrates a method of optimizing a player gaming experience, according to an embodiment of the present disclosure.

Like reference numerals refer to like parts throughout the several views of the drawings.

### DETAILED DESCRIPTION OF THE INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims. An AI-guided omnichannel shopping system for providing a personalized shopping experience and method thereof is discussed herein. In the following description, for purposes of explanation, numerous specific details are set forth in order to provide a thorough understanding of the present invention. It will be evident, however, to one skilled in the art that the present invention may be practiced without these specific details. The present disclosure is to be considered as an exemplification of the invention and is not intended to limit the invention to the specific embodiments illustrated by the figures or description below. The present invention will now be described by referencing the appended figures representing preferred embodiments.

The following description with reference to the accompanying drawings is provided to assist in a comprehensive understanding of exemplary implementations of the invention. It includes various specific details to assist in that understanding but these are to be regarded as merely exemplary.

Features that are described and/or illustrated with respect to one implementation may be used in the same way or in a similar way in one or more other implementations and/or in combination with or instead of the features of the other implementations.

The present invention relates to a real-time system where users of real-time 3-D software can adjust the rendering performance and quality of the software run on a user device, by making quantifiable choices within the context of a total quantifiable capacity of the user devices' specific hardware capabilities.

According to embodiments, the user device includes a personal computer, a tablet, a mobile device, a gaming console, or the like, having at least one dedicated graphics processing unit (GPU) along with at least one central processing unit (CPU).

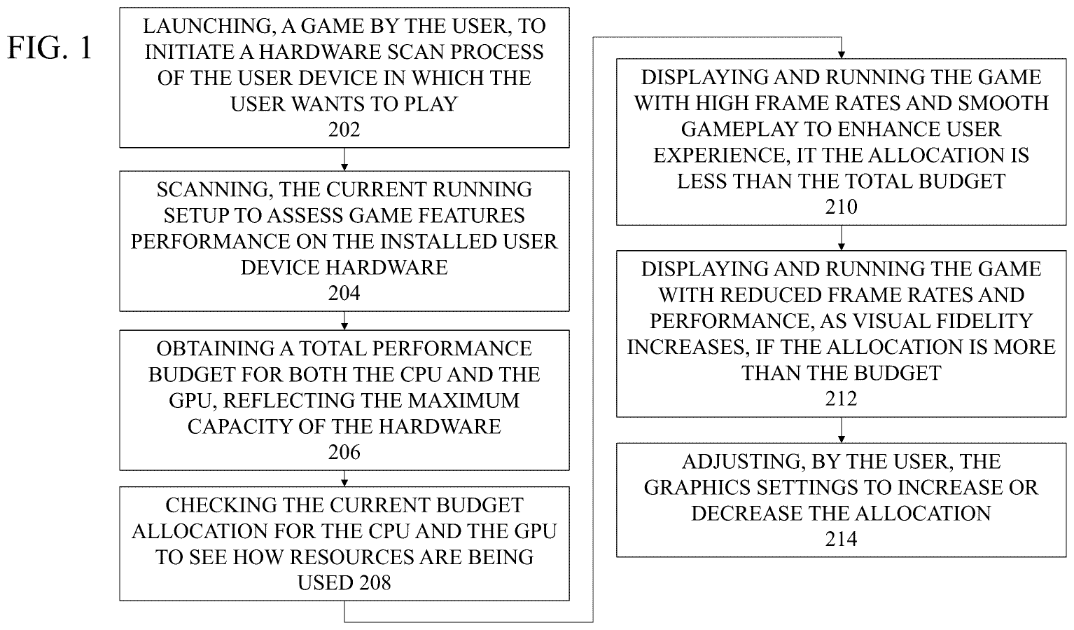

As shown in FIG. 1, according to an embodiment, a real-time method for controlling rendering performance and quality of a 3-D software run on a user device, by making quantifiable choices by a user, is provided. Initially, a user launches a game to initiate the hardware scan process of the user device in which the user wants to play 202. The current running setup is scanned to assess how game features perform on the installed user device hardware 204. A total performance budget for both the GPU and the CPU is obtained, reflecting the maximum capacity of your hardware 206. The current budget allocation for GPU and CPU is obtained to see how resources are being used 208. If the allocation is less than the total budget, the user experiences high frame rates and smooth gameplay 210. A larger gap between allocation and budget indicates better performance and if the allocation exceeds the total budget, the user experiences reduced frame rates and performance, as visual fidelity increases 212. The user can adjust the graphics settings which causes the allocation to increase or decrease 214. Some settings have higher impact than others. User can increase the quality of a settings they care more about.

According to an exemplary implementation, a computer Performance Budget Tool (PBT) allows a user to customize a graphics setting and performance of a game based on hardware of the user computer. The PBT assesses the computer's GPU and CPU to determine the available performance budget. The tool then recommends graphics setting to take best advantage of game based on the computer's available hardware. Each setting uses a certain amount of budget. Adjusting the quality of those settings changes how much of the budget that setting uses, so that user can use exactly which quality for which setting is important to them.

Upon launching the game, the game calculates the budget using this tool. This tool provides performance insights to specific functions on user hardware. After calculating the budget, the game then presets the graphics settings to recommended levels based on your hardware. Adjusting the graphics settings causes the allocation to increase or decrease. Some settings have higher impact than others. User can increase the quality of a settings they care more about.

The user gets the exact knowledge of their hardware and can optimize the performance either by the adjusting the settings to match the budget or by quitting the extra running application to increase the budget, or by both the ways. These tools allows user to get information of their GPU and CPU both rather than only one. Also, user can change and optimize the settings in real-time.

According to an embodiment, in the real-time 3D performance management system, quantifiable values are associated to various measurable aspects (MA) of a video game that impact it's rendering frame rate and visual quality (RFRVS). The users (or developer selected settings/defaults) can select each MA value from that aspect's range of values, where the range represents a spectrum of quality, with one side of the spectrum being associated with a greater impact on the RFRVS (each selection is a Measurable Aspect Selection, or MAS), where this impact may be overall or for a specific processor within the computer (such as Central Processing Unit or Graphics Processing Unit). A total sum of MAS represents the software's performance settings. A total capacity for each processor (each a “Processor Capacity”) that the game can use to achieve RFRVS, which is a combination of processor type, memory available to that processor, and other aspects of that processor's connection within the computer that determines its capabilities, whose capacity is determined by a separate benchmarking tool. The system provides an interface to compare the Software's Performance Settings to the processor capacity and provide visual and instructional feedback if the Performance Settings are below, near or at, or exceeding each processor capacity.

The system and the method thereof gives users (Computer players) granular control over how exactly their machines' power is used. The Performance Budget Tool, which integrates with the game's graphics settings menu gives players detailed information about how graphical choices impact the performance of game on their specific machines. This performance budget tool lets the user decide what settings you want for the game's performance and visual quality. A user's budget is based on the user computer's GPU and CPU processing capabilities. The user can re-calculate the budget at any time using a Reset Button. With experimentation, the user sees that some settings use more of your budget than others. If you are under budget, the game may run faster, such as achieving a higher maximum framerate. Settings near the budget sees the best balance of performance and visual fidelity. Exceeding the budget increases the game's visual fidelity at the cost of running at a lower framerate. The user can click the Reset Button to re-calculate the budget and return to the recommended settings for your specific GPU and CPU.

When the user first launches the game, it scans your whole running setup to determine how specific features of an Unreal Engine 5.1 are likely to perform on the hardware. It then provides a total “budget” that you have to play with for both your GPU and CPU, representing the power of specific to the user device, and displays a budget total for your GPU and another for the CPU along with the current budget allocation. If the allocation is lower than the total budget, the user can expect to see high frame rates and smooth performance- and the more room between those numbers, the faster the game will run. Conversely, if the allocation exceeds the total budget, the user can expect to see the framerate and performance begin to decrease as visual fidelity increases. Keeping the allocation as close as possible to the budget total (without going over) gives the best balance of performance and visual fidelity.

In conjunction with this, each graphical setting is accompanied by numbers indicating how much of your total GPU and CPU budget it requires, which update as a user cycle between different levels of each setting. As a result, you're able to see very quickly how different settings impact your budget, and thus the game's performance on your PC. This lets you fine-tune your graphics settings to focus on the things you care about and get an idea of precisely how your choices impact performance in real time, without having to resort to trial and error.

The tool accounts for the entire workload on the GPU and CPU at the time of the scan, including any other applications that are currently running. If a user finds a few points short of the ideal configuration for running the game/software, the user might be able to quit out of/close some non-essential applications and perform rescan by clicking the “Reset” button, to determine the revised budget after all. The user may find that the user have enough overhead to run something in the background, thereby providing detailed information in order to facilitate the user to make educated decisions about graphical choices.

Some of the non-limiting advantages of the real-time performance management of a user device and a related method for controlling computer rendering performance and quality are that the user gets the exact knowledge of the hardware of their user device. The user can optimize the performance either by the adjusting the settings to match the budget or by quitting the extra running application to increase the budget, or by both the ways. The user can use tools which allows user to get information of their GPU and CPU both, rather than only one. Also, user can change and optimize the settings in real-time.

Although a real-time performance management of a 3-D software run on a user device and a related method for controlling computer rendering performance and quality has been described in language specific to structural features, it is to be understood that the embodiments disclosed in the above section are not necessarily limited to the specific methods or devices described herein. Rather, the specific features are disclosed as examples of implementations of real-time performance management of a 3-D software run on a user device and a related method for controlling computer rendering performance and quality.

While the present invention has been described in terms of particular embodiments and applications, in both summarized and detailed forms, it is not intended that these descriptions in any way limit its scope to any such embodiments and applications, and it will be understood that many substitutions, changes and variations in the described embodiments, applications and details of the method and system illustrated herein and of their operation can be made by those skilled in the art without departing from the spirit of this invention. In some embodiments, the method or methods described above may be executed or carried out by a computing system including a tangible computer-readable storage medium, also described herein as a storage machine, that holds machine-readable instructions executable by a logic machine (i.e. a processor or programmable control device) to provide, implement, perform, and/or enact the above described methods, processes and/or tasks. When such methods and processes are implemented, the state of the storage machine may be changed to hold different data. For example, the storage machine may include memory devices such as various hard disk drives, CD, flash drives, cloud storage, or DVD devices. The logic machine may execute machine-readable instructions via one or more physical information and/or logic processing devices. For example, the logic machine may be configured to execute instructions to perform tasks for a computer program. The logic machine may include one or more processors to execute the machine-readable instructions. The computing system may include a display subsystem to display a graphical user interface (GUI) or any visual element of the methods or processes described above. For example, the display subsystem, storage machine, and logic machine may be integrated such that the above method may be executed while visual elements of the disclosed system and/or method are displayed on a display screen for user consumption. The computing system may include an input subsystem that receives user input. The input subsystem may be configured to connect to and receive input from devices such as a mouse, keyboard or gaming controller. For example, a user input may indicate a request that certain task is to be executed by the computing system, such as requesting the computing system to display any of the above described information, or requesting that the user input updates or modifies existing stored information for processing. A communication subsystem may allow the methods described above to be executed or provided over a computer network. For example, the communication subsystem may be configured to enable the computing system to communicate with a plurality of personal computing devices. The communication subsystem may include wired and/or wireless communication devices to facilitate networked communication. The described methods or processes may be executed, provided, or implemented for a user or one or more computing devices via a computer-program product such as via an application programming interface (API).

Since many modifications, variations, and changes in detail can be made to the described preferred embodiments of the invention, it is intended that all matters in the foregoing description and shown in the accompanying drawings be interpreted as illustrative and not in a limiting sense. Furthermore, it is understood that any of the features presented in the embodiments may be integrated into any of the other embodiments unless explicitly stated otherwise. The scope of the invention should be determined by the appended claims and their legal equivalents.

The present invention has been described with reference to the preferred embodiments, it should be noted and understood that various modifications and variations can be crafted by those skilled in the art without departing from the scope and spirit of the invention. Accordingly, the foregoing disclosure should be interpreted as illustrative only and is not to be interpreted in a limiting sense. Further it is intended that any other embodiments of the present invention that result from any changes in application or method of use or operation, method of manufacture, shape, size, or materials which are not specified within the detailed written description or illustrations contained herein are considered within the scope of the present invention.

What is claimed:

1. A real-time method for controlling rendering performance and quality of a 3-D software run on a user device, by making quantifiable choices by a user, said user device having at least one graphics processing unit (GPU) and at least one central processing unit (CPU), the method comprising:
launching, a game by the user, to initiate a hardware scan process of the user device in which the user wants to play;
scanning, a current running setup to assess game features performance on the installed user device hardware;
obtaining a total performance budget for both the GPU and the CPU, reflecting a maximum capacity of the hardware;
checking a current budget allocation for GPU and CPU to see how resources are being used;
displaying and running the game with high frame rates and smooth gameplay to enhance user experience, if the allocation is less than the total budget;
displaying and running the game with reduced frame rates and performance, as visual fidelity increases, if the allocation is more than the total budget; and
adjusting, by the user, the graphics settings to increase or decrease the allocation.

2. A real-time performance management system for controlling rendering performance and quality of a 3-D software run, by making quantifiable choices by a user, the system comprising:
a user device having at least one graphics processing unit (GPU) and at least one central processing unit (CPU), said user device is configured to:
launch, a game by the user, to initiate a hardware scan process of the user device in which the user wants to play;
scan, the current running setup to assess game features performance on the installed user device hardware;
obtain a total performance budget for both the GPU and the CPU, reflecting the maximum capacity of the hardware;
check the current budget allocation for GPU and CPU to see how resources are being used;
display and run the game with high frame rates and smooth gameplay to enhance user experience, if the allocation is less than the total budget;
display and run the game with reduced frame rates and performance, as visual fidelity increases, if the allocation is more than the total budget; and
adjust, by the user, the graphics settings to increase or decrease the allocation.
